(19) United States
(12) Patent Application Publication
(10) Pub. No.: US 2011/0138330 A1
(43) Pub. Date: Jun. 9, 2011

(54) DISPLAY OF RELATIONAL DATASETS

(75) Inventors: Christopher J. Sanders, San Jose, CA (US); William Martin Bachman, San Jose, CA (US); Timothy B. Martin, Sunnyvale, CA (US)

(73) Assignee: Apple Inc., Cupertino, CA (US)

(21) Appl. No.: 12/630,789

(22) Filed: Dec. 3, 2009

(51) Int. Cl. G06F 3/048

(52) U.S. Cl. 715/835

(57) ABSTRACT

Displaying and navigating items in an ordered list within a graphical user interface for viewing and utilizing the data are disclosed. An ordered list of data items can be used to generate an icon that represents the contents of the list. The icon can comprise images that best represent the items in the ordered list by choosing images associated with the highest ranked items in the ordered list. When the ordered list is selected by selecting the icon with a pointing device or keyboard the icon transforms to display an image of a currently selected data item with navigational controls. The navigational controls can receive inputs from a pointing device or keyboard to allow a user to navigate or browse through the items in the list without having to open a new view.

### FIELD

The following relates to organizing ordered datasets and more specifically relates to a graphical user interface for displaying and browsing ordered datasets.

### BACKGROUND

Data is becoming increasingly important and abundant in daily life. Accordingly, improved methods of viewing and managing data are required. Conventional methods of storing and viewing files such as directory file folders and indexes either present data poorly or are time consuming to navigate.

For example, file folders can organize files, but require searching for files. Data is easily lost and forgotten. While improvements such as tiled icons showing several images contained within a folder have made navigating a directory structure a little easier, the images often are not the most relevant images from that directory and browsing the contents of the directory requires opening the directory folder.

Likewise, indexes are useful for searching for forgotten files, but they are limited by the search query and poor visualization of search results. Additionally, browsing the search results requires opening each file individually.

Other methods of viewing and browsing datasets also exist, but are dataset specific and cannot be used to view a variety of datasets.

Improved methods of managing, viewing and navigating data whether in a file system structure, a query of an index, or any other dataset such as tables or lists are needed.

### SUMMARY

The following relates to displaying and navigating items in an ordered list. The present systems and methods receive an ordered dataset and generate a graphical user interface for viewing and utilizing the data.

In a simple example, an ordered list of data items can be used to generate an icon that represents the contents of the list. The icon can comprise images that best represent the items in the ordered list by choosing images associated with the highest ranked items in the ordered list. The images create an icon made up of a mosaic of the images. When the ordered list is selected by selecting the icon with a pointing device or keyboard the mosaic icon transforms to display only an image of a currently selected data item within the ordered list and translucent navigational controls. The navigational controls can receive inputs from a pointing device or keyboard to allow a user to navigate or browse through the items in the list without having to open a new view. The presently selected item is displayed as the full icon and changes as new items are selected. When the ordered list is no longer selected the icon returns to the mosaic icon representing the whole list.

In some embodiments, the ordered list describes multiple subsets of a larger collection of data items. In some embodiments, the multiple subsets are clusters of related data items. The systems and methods described herein generate mosaic icons descriptive of each subset and spatially layout and order the icons based on the order of importance for each cluster of data. The order of importance can be determined based on size of the cluster or based on other information about the files contained within the subsets. However the order is determined, it becomes substantially set so that a user can identify the subset based not only on the icon, but also from its location in the graphical user interface.

### BRIEF DESCRIPTION OF THE DRAWINGS

FIG. 1 illustrates an exemplary graphical user interface embodiment;

FIGS. 2A-2C illustrates exemplary dataset embodiments;

FIG. 3 illustrates an example method embodiment;

FIG. 4 illustrates an example method embodiment for generating icons displayed in the GUI;

FIG. 5 illustrates an example icon embodiment displayed in the GUI;

FIG. 6 illustrates an example layout embodiment of the disclosed GUI;

FIG. 7 illustrates an example layout embodiment of the disclosed GUI; and

FIG. 8 illustrates and example system embodiment.

### DESCRIPTION

In preferred embodiments, the present technology is applied to datasets corresponding to digital media libraries and creates a graphical user interface for utilizing these datasets in a media playback and management application, such as ITUNES by Apple Inc., Cupertino, Calif.

Just as with any other collection of data, whether numbers or media files, various statistical analyses can be performed on the data to result in a desired output. The present technology applies to any collection of data that can be organized into a dataset having ranking or ordering information to allow organization of the data. For example, a collection of media items can be analyzed and a dataset that orders the media items from most similar to a given data point (another song or collection perhaps) to least similar would be a dataset that can be presented with the present technology. The dataset, in its most simple form, can be an ordered list.

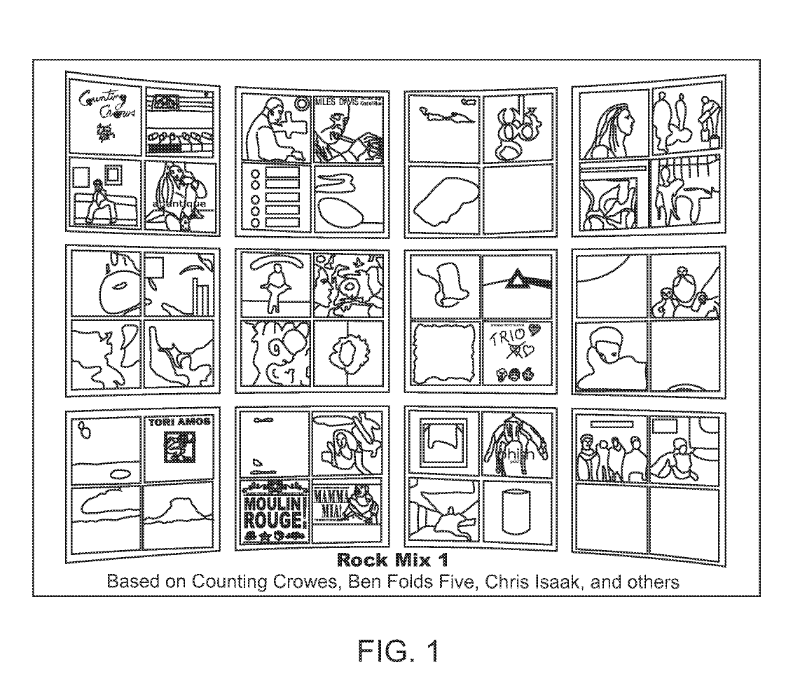

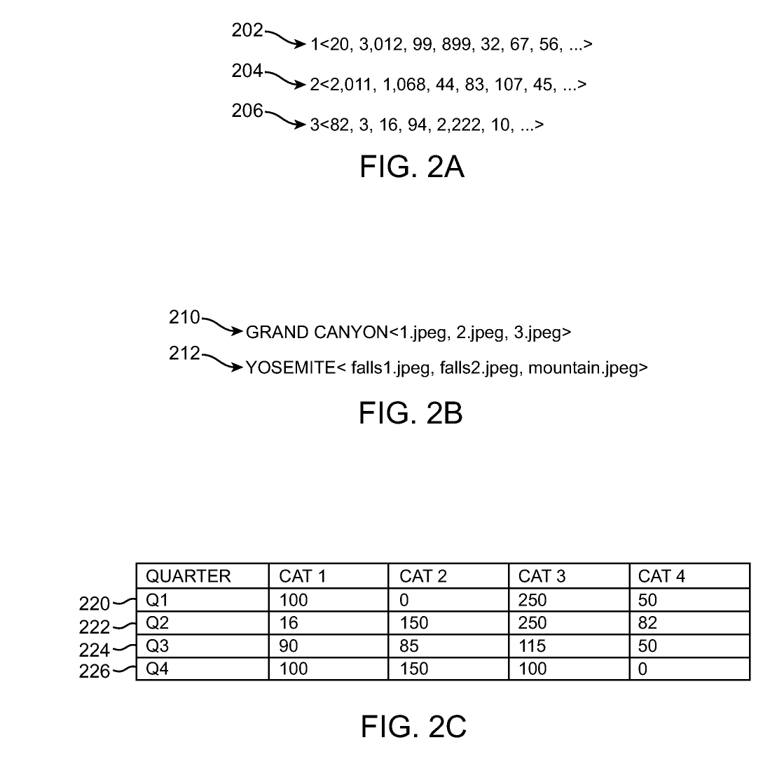

In some embodiments, the graphical user interface described herein can be applied to a collection of ordered lists within a dataset. In the embodiments wherein the data is a collection of media items, the dataset can represent divisions of a media library into a plurality of groupings and be displayed in a graphical user interface (GUI) as seen in FIG. 1. Underlying each grouping is data that ranks the media items according to the strength of their relationship to the other items in the group. An example of such a dataset is illustrated in FIG. 2A. Data subsets 202, 204, and 206 each represent a division of collection of media items in a user's media library. Subset 202 represents the first division or collection within the library and it contains audio tracks identified by numerical identifiers. Accordingly subset 202 contains audio tracks 20, 3,012, 99, 899, 32, 67, 56, and others. The tracks listed can be organized from best to worst for a desired relationship. In some embodiments, the songs are listed according to their relationship to the other songs in the subset. In the case of subset 204, item 2,011 has the strongest relationship to all the other audio tracks in subset 204 because it is listed first in the subset.

In some embodiments, the ordering of the dataset is a ranking of an items similarity relationship to the other items in the dataset or subset. The similarity can be similar as judged by any useful parameter. In some embodiments similarity can be judged in a clustering context wherein an item's similarity can be based on how similar the item is to the collective average of the items in the cluster. In some embodiments similarity is relative to a chosen parameter. The parameter can be as complex as an analysis of how related one item is to other items based on many variables and in other embodiments the parameter can be a relationship to the beginning of the alphabet to result in an alphabetical listing. In sum, any analysis that can rank the items within a dataset or ordered dataset is sufficient for use in ordering the dataset.

FIG. 2B illustrates another type of data category that can be organized and browsed using the present technology. FIG. 2B represents a folder in a typical computer directory structure containing subfolders organizing image files of images of various national parks. Subset 210 “Grand Canyon” contains images 1.jpeg, 2.jpeg, 3.jpeg, and others of the Grand Canyon, which are ranked in an order and subset 212 “Yosemite” contains images of Yosemite. In this example the dataset is organized simply by name.

FIG. 2C illustrates yet another type of data category that can be displayed and browsed using the present technology. In FIG. 2C a table is illustrated and the subsets 220, 222, 224, and 226 correspond to the rows of the table representing financial year quarters. The subsets could also correspond with the columns or any other organization that makes sense. The ordering can come from the ordering within the table.

The type of dataset, meaning of the data and the ordering scheme of the data can be irrelevant to the present technology.

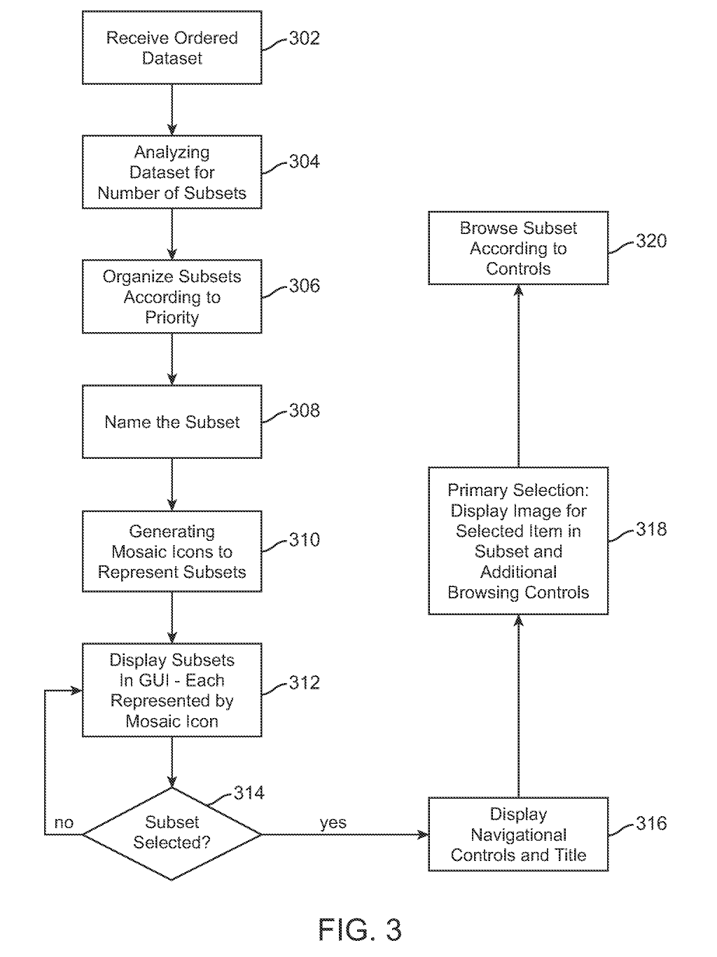

As illustrated in FIG. 3, the system receives an ordered dataset (302) and analyzes the dataset to determine the number of subsets (304) and the respective priority of the subsets (306). As shown in FIG. 2, in some embodiments the subsets are readily determinable from the structure of data, wherein the structure or content of the data can delineate subsets. However, in some embodiments the subsets themselves can be further analyzed to determine subsets of those subsets. Several different subset analyses are known in the art. For example, clustering analysis can identify clusters of related items within a larger collection of data.

Depending on how many subsets are recognized (304), the system will need to choose how many subsets to display and which subsets to display, if not all. Large datasets potentially have numerous subsets, and displaying more information than the user can easily manage is not helpful. In some embodiments, no more than twelve subsets are displayed at any time. In some embodiments, the arrangement of the subsets is selected to be aesthetically pleasing and so certain odd arrangements of subsets are avoided. In some embodiments, only arrangements that provide for a rectangular arrangement of subsets are allowed (e.g. 1×1, 2×2, 3×3, 3×4).

The priority of the subsets can also be determined (306) from an analysis of the data. In some embodiments, the subsets are already ordered according to priority. In some embodiments the largest subsets are given the highest priority. In some embodiments, metadata associated with the collection of data represented within the subset can be used to determine the priority of the subsets. For example, in the case of a music library as the underlying collection of data, metadata associated with the music items can be used to determine the priority of the data. Subsets having the greatest number of highly ranked or often played items could be given priority over other datasets. Subsets given a higher priority will be displayed before subsets given a lower priority (if not all subsets can be displayed) and will also be given preferential display position in the GUI (as explained below).

Each subset is given a default name (308) based on its predominant characteristics and a determined naming convention. The system analyzes the metadata associated with the dataset, and if the underlying collection of data is a collection of files, the names of the files and metadata associated with those files can be used to determine a default name. In some embodiments, the default name can be based on the file names of the top items in a subset. In some embodiments, the default name is based on a predominate shared characteristic of the individual data items in the dataset.

With reference to the collection of music items example, the subset can be named based on a predominant genre of the music items in the subset. If multiple subsets share the same default name, a number is added at the end of the name to distinguish the subsets. For example, if the subsets are named based on predominant genre, a formula for naming the subset can be: <GenreName>+<increment>, wherein the Genre Name is the predominant genre or genres and the increment is the number added at the end to distinguish between two similarly named subsets. If no information is available to generate a default name, the subset can be called “Untitled.” Again increments can distinguish multiple untitled subsets.

In some embodiments further description of the datasets is provided. Further analysis of the datasets can reveal more descriptive information of the items in the subset. For example, a subset might contain media items from the same artist or album. The subset can include a “Based On” subtitle that lists descriptive information about the items in the subset. In this example, each subset has a set of artists that are listed below its title to give users an indication of the subset's content. These artists are the most representative of the subset, as determined by the algorithm. The “Based On” tag is as follows: Based On <artist 1>, <artist 2>, <artist 3>, and others. For example: “Based on Counting Crows, Red Hot Chili Peppers, Dave Matthews, and others.”

Any number of artists or other additional information can be listed. It can also be useful to order the additional information by influence or importance to the dataset.

The display of the icons or tiles (310) is similarly generated based on an analysis of the dataset. The analysis consists of identifying the top items represented within the dataset and displaying a mosaic icon or tile of a collection of images that represent the top items in the subset. Since, the dataset contains ordered information the top items should be easily identified and are often the first data appearing in the dataset. In many instances the top items will be the most representative items in the set. By displaying a collection of several graphics representing the top items in the list the most relevant information can be displayed and easily viewed by a user.

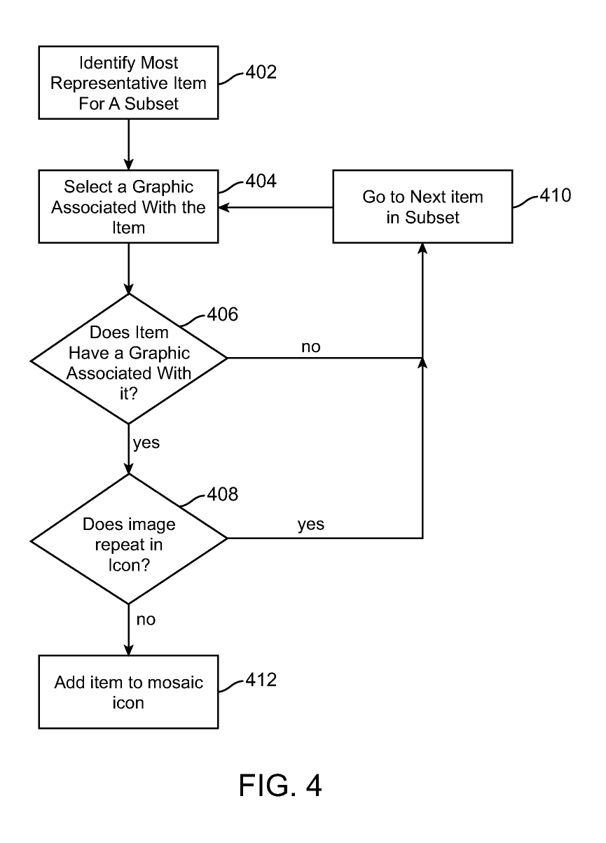

As illustrated in FIG. 4, the top item in the ordered dataset or subset is identified (402) and a graphic that represents the item is selected (404). The graphic could be a miniature of the first page of a document, or the album cover of an audio track as examples. If any of the songs are from albums without artwork, they should be skipped (408) and the next option chosen (410). If no graphics are available for any of the items in the subset a fill-in graphic can be used. If the graphic is already represented in the tile (this would occur if another item in the tile is from the same album), they should be skipped (406) and the next option should be chosen. This process can be repeated for any number of items to make up the icon provided that they fit in the allotted space and are recognizable. In some embodiments the number of items to displayed in any one icon is four. These graphics correspond to the four most influential, songs in the subset that do not repeat the same graphics within the icon. When all locations in the icon or tile are filled, the mosaic is completed (412).

The exceptions above can also apply across multiple subsets. If any of the songs are from artists already represented in one tile, the next artist in a different subset can be used to increase the variety. Even when the same artwork will be used in more than one tile, the artwork should be given a different position in the respective tiles.

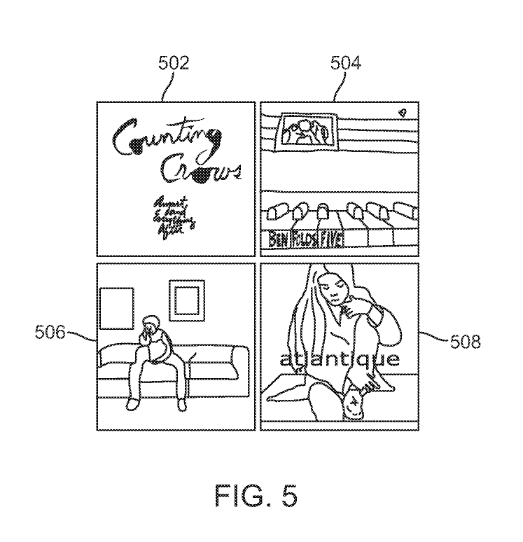

FIG. 5 illustrates a complete mosaic showing four images 502, 504, 506, 508, each associated with a file, a song, selected according to the rules discussed above.

As determined above, a selected number of subsets are to be displayed (304). In some embodiments the subset icons or tiles are arranged in a grid and displayed (312). Icons or tiles are initially sorted by significance. That is, the icon that represents the largest subset of the user's Library comes first, and the subset that represents the smallest section comes last.

However, any arrangement can be used provided the layout can be generally maintained during window resizing. Some rearrangement can be accommodated; however, it is minimized so that subsets can be relocated based in part on its position in the arrangement.

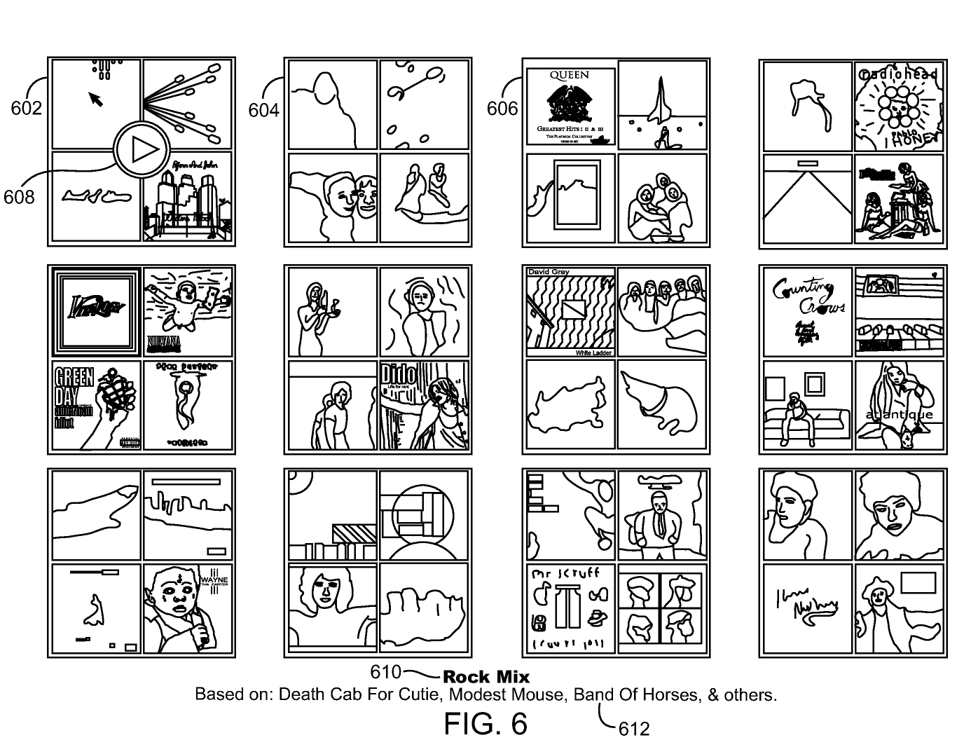

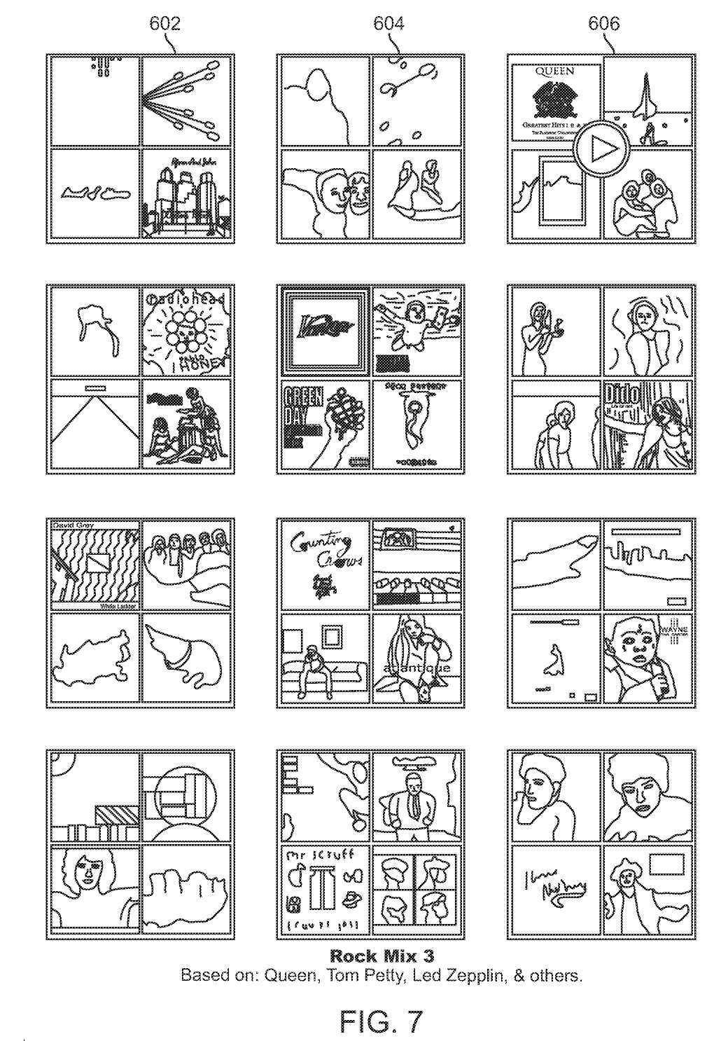

See for example, FIGS. 6-7. FIG. 6 shows the arrangement of icons in a 4×3 grid while FIG. 7 shows the icons in a 3×4 grid. The shape of the window that displays the GUI necessitates the change in arrangement. Notice that subsets 602, 604, 606 maintain their arrangement in the top row and their arrangement relative to each other. In this way, the highest priority clusters maintain their position in the interface. Other subsets retain their position according to rank in the interface, but some subsets are relocated. By minimizing disruption to the organizational scheme of the icons, users can locate subsets much like paper on a desk; they can remember where in the interface to locate the subset. Rearrangement should not be necessary when scaling the size of the window, but only when the shape of the window is changed in such a way that is benefited from the rearrangement. However, users may command-drag mixes to new locations, causing the other mixes to dynamically repaginate.

In some embodiments rearranging subsets is minimized even when the underlying data is updated and the subsets are modified. In some embodiments, when the underlying data is updated and the data analysis (304) is subsequently repeated, the new subsets should be matched, if possible to the original subsets and presented in the same location in the interface so that a user can easily locate a subset (s)he is used to finding in a particular location. Old and new subsets can be matched until less than 90% or 80% or 75% of the items in the respective subsets match. Subsets with greater divergence can be generated as if they are new subsets.

In some embodiments the icons or tiles can also be used for browsing the dataset or subset in response to inputs. A pointing device can be used to select a subset (314). In some embodiments the user can initiate a hover action, wherein the pointing device is positioned over an icon or tile, but the icon is not clicked, to display secondary selection options (316) such as selection controls (608) and title (610) as illustrated in FIG. 6 as 602. In response to the Hover action the title (610) and additional description (612) can be displayed. Further a play icon can be displayed (608). The play control icon can be opaque or translucent.

The pointing device can also be used to input a selection command by clicking on the selected icon. Clicking on the icon activates primary selection of the icon (318) and can be accompanied by a variety of actions. Clicking can initiate browsing of the subset represented by the icon. In some embodiments, the mosaic view for the selected icon switches to display only icon(s) that represent the first item in the dataset. In some embodiments, music can accompany the display of the icon(s) when the items in the dataset represent music or audio tracks.

Clicking can also cause additional browsing controls (608) to be presented. The play icon can switch to a pause icon and/or can be joined by fast-forward and rewind icons. Clicking on these icons will result in navigating forward and backward through the underlying dataset (320). As the dataset is navigated the icon can switch to display a graphic that is associated with the currently selected item in the dataset.

In some embodiments, additional features can be enabled or disabled depending on the nature of the underlying data set. For example, if the underlying data is a collection of music or audio tracks, the subsets can be useful for browsing related subsets of the audio collection and additional features relevant to audio data can be enabled.

In addition to playing browsed items, the subsets can be useful in generating playlists of music, which can also be played and browsed in a similar manner as described above. In the example of using the underlying dataset to create a playlist, the dataset can itself be a playlist, or a list of candidates for a playlist. In embodiments wherein the subset is a collection of candidates for a playlist, candidates can be selected by random or by using a playlist creation algorithm. In one embodiment playlists can be created by selecting music items from the list of candidates to use a seed items for generating a playlist of similar music items. Similar music items can be identified from a similarity analysis. Various similarity analyses are known in the art for example similarity relationship can be identified based on items that are commonly purchased or browsed together by users. AMAZON.com uses this type of similarity relationships. Other similarity relationships can be identified based on the characteristics of the music itself. PANDORA.com uses this type of analysis. APPLE INC. uses an analysis of music items that co-occur in many different user's media libraries to determine that two or more items are similar. Any of these similarity analyses can be used to generate a playlist based on seed items.

When the subset is used to create a playlist, the playlist can play to its completion and then be refreshed to continue to play. In some embodiments the same song is excluded from a playlist in two consecutive refreshes.

In some embodiments when a new subset of data is selected to be browsed the previous subset retains its browsing position. In some embodiments the browsing position can return to the top of the ordered list.

In some embodiments, the graphical user interface is used to display clusters of music media items within a user's media library. An analysis of the contents of the media library reveals clusters of media items that are considered similar to each other. The stronger the relationship any item has to the other items in the cluster the higher the rank the item is given in the cluster. In such embodiments, the present system can use the cluster data to generate icons based on the clusters in the user's media library. Moving a pointing device over a cluster can reveal the name of the cluster and any additional description of the contents of the cluster as described herein. Clicking on the cluster can begin playback. The songs within the cluster are played based on a playlist that is generated by a playlist algorithm. The playlist can be navigated using forward and backward controls that can be displayed within the icon representing the cluster or are part of a user input device such as a mouse or keyboard or touch screen.

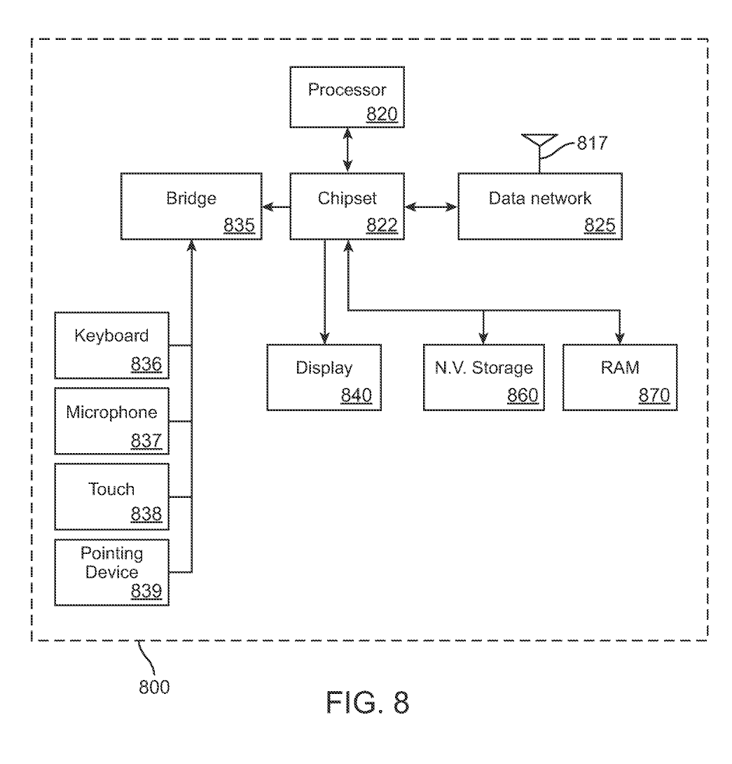

FIG. 8 illustrates a computer system 800 used in executing the described method and generating and displaying the GUI. Computer system 800 is an example of computer hardware, software, and firmware that can be used to implement disclosures below. System 800 includes a processor 820, representative of any number of physically and/or logically distinct resources capable of executing software, firmware, and hardware configured to perform identified computations. Processor 820 communicates with a chipset 822 that can control input to and output from processor 820. In this example, chipset 822 outputs information to display 840, and can read and write information to non-volatile storage 860, which can include magnetic media, and solid state media, for example. Chipset 822 also can read data from and write data to RAM 870. A bridge 835 for interfacing with a variety of user interface components can be provided for interfacing with chipset 822. Such user interface components can include a keyboard 836, a microphone 837, touch detection and processing circuitry 838, a pointing device, such as a mouse 839, and so on. In general, inputs to system 800 can come from any of a variety of sources, machine generated and/or human generated.

Chipset 822 also can interface with one or more data network interfaces 825 that can have different physical interfaces 817. Such data network interfaces can include interfaces for wired and wireless local area networks, for broadband wireless networks, as well as personal area networks. Some applications of the methods for generating and displaying and using the GUI disclosed herein can include receiving ordered datasets over physical interface 817 or be generated by the machine itself by processor 820 analyzing data stored in memory 860 or 870. Further, the machine can receive inputs from a user via devices 836, 837, 838, 839 and execute appropriate functions, such as browsing functions by interpreting these inputs using processor 820.

Methods according to the above-described examples can be implemented using computer-executable instructions that are stored or otherwise available from computer readable media. Such instructions comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality also can be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer implemented method comprising:
identifying a subset of a collection of media items based on an analysis of a dataset;
ranking the media items based on each media items gravity;
displaying a graphical mosaic icon representing the subset of the collection of media items, the mosaic icon comprising images associated with media items of the subset;
switching the mosaic representing the subset to an image associated with a selected media item within the subset responsive to selection of the subset; and
presenting controls that are responsive to user inputs overlaid the icon representing the subset for browsing the contents of the subset.

2. The method of claim 1, wherein the subset comprises multiple subsets of the collection of media items and each of these subsets is represented by a respective graphical mosaic icon comprising images associated with media items contained within that subset.

3. The method of claim 1, wherein the items of the subset are relatively ordered based on a criteria.

4. The method of claim 3, wherein the criteria comprises a measure of each items fit within the subset.

5. The method of claim 3, wherein the criteria comprises a measure of each items similarity to other members of the subset.

6. The method of claim 3, wherein the items in the subset are ranked, and the mosaic icon is comprised of images associated with at least two top ranked items in the subset.

7. The method of claim 3, wherein the items in the subset are ordered by a ranking and mosaic icon is comprised of images associated with four top ranked items in the subset.

8. The method of claim 3, wherein the images that make up the icon representing the subset are associated with the top items of the subset that do not repeat an image used in the mosaic icon.

9. The method of claim 3, wherein the images that make up the icon representing the subset are associated with the top items of the subset that are not associated with an author of an item that has already been used in the mosaic icon.

10. The method of claim 1, further comprising naming the subset by determining a predominant genre corresponding to the media items within the subset and naming the subset after the predominate genre.

11. A computer-readable medium storing computer executable instructions for causing a computer to perform the method comprising:
identifying subsets of a collection of media items based on an analysis of an ordered dataset;
representing the subsets of the collection of media items as graphical mosaic icons comprising images associated with media items contained within the respective subsets;
arranging the locations of the icons representing the subsets within a graphical user interface (GUI) according a priority determined from the analysis of the ordered dataset; and
maintaining the relative location of the icons representing the subsets relative to each other within the GUI.

12. The computer-readable medium of claim 11, further comprising generating a name and a description of each subset that is descriptive of the media items within subset.

13. The computer-readable medium of claim 11, wherein the name is generated based on a predominant genre(s) of media items represented in the dataset.

14. The computer-readable medium of claim 11, wherein the description is generated based on authors having the greatest number of songs within the subset.

15. The computer-readable medium of claim 11, wherein the icon further comprises navigational controls for navigating among the media items in the subset.

16. The computer-readable medium of claim 11, further comprising switching the icon from the mosaic to an image associated to a currently selected media item within the subset when the subset is selected.

17. A device comprising:
a processor configured to identify multiple subsets of a collection of media items based on an analysis of a dataset and represent the subsets as a graphical mosaic icon comprising images associated with media items contained within the respective subsets;
a user interface configured to receive inputs and communicate the inputs to the processor, upon receiving an input selecting one of the subsets the processor switching the icon representing the selected subset from the mosaic to an image associated with a currently selected media item within the selected subset and presenting controls that are responsive to additional user inputs for browsing the contents of the selected subset; and
a display for visually presenting the graphical user interface based on the output of the processor.

18. The device of claim 17, wherein the analysis of the dataset ranks the media items within the respective subsets of the collection of media items based on the respective media item's similarity to the collective media items making up the respective subset and selecting images associated with at least two of the items having the highest rank to comprise the graphical mosaic icon representing the subset.

19. The device of claim 17, wherein the processor is further configured to arrange the icons representing the subsets within a the user interface according a priority determined from the analysis of the dataset and maintain the relative location of the icons representing the subsets relative to each other within the user interface.

20. The device of claim 19, wherein the processor is further configured to generate a name and a description of each subset that is descriptive of the media items within subset.

21. The device of claim 20, wherein the processor is further configured to generate the name based on a predominant genre(s) of media items represented in the dataset.

22. The device of claim 20, wherein the description is generated based on authors having the greatest number of songs within the subset.
